(19) United States
(12) Patent Application Publication
(10) Pub. No.: US 2017/0318775 A1
(43) Pub. Date: Nov. 9, 2017

(54) WINDOW BOX PET ENCLOSURES AND METHODS TO MAKE THE SAME

(71) Applicant: Cynthia Chomos, Seattle, WA (US)

(72) Inventor: Cynthia Chomos, Seattle, WA (US)

(21) Appl. No.: 15/584,944

(22) Filed: May 2, 2017

Related U.S. Application Data
(60) Provisional application No. 62/331,170, filed on May 3, 2016.

(51) Int. Cl. A01K 1/03; A01K 1/035

(52) U.S. Cl. CPC A01K 1/033; A01K 1/035; A01K 1/03; A01K 1/031; A01K 1/034; A01K 1/032

(57) ABSTRACT

A pet enclosure that is coupleable to a wall structure of a home adjacent to a window, where the window provides a first access point to a pet can include a frame structure coupled to the wall structure of the home, the frame structure having an opening which is located adjacent to the window, the frame structure including a second access point; and a corbel assembly coupled to the frame structure and the wall structure of the home. Related methods are also provided.

### BACKGROUND

### Technical Field

The present disclosure is directed to pet enclosures and, more particularly, to pet enclosures for small pets, which are coupled to an exterior wall structure of a home.

### Description of the Related Art

Pets often need to access outdoors from an interior of a home. Pet owners typically provide an exterior structure that is connected to the home via an access point, which allows pets to exit the home to a secure and enclosed exterior structure. Generally, such exterior structures, particularly above-ground enclosures for windows, consist of a wood and/or wire cage structure with a wire cage roof or metal roof that projects out from a window of the home. Such exterior structures typically include one access point, for example, a window that has to be opened to provide pet access or, in some instances, a pet door installed in the window. Such exterior structures, however, are disadvantageous in that, when there are emergencies, access to the pet by adult pet owners is limited by the pet door and/or door insert, which may require removal and/or destruction of the pet door and/or portions of the window based, in part, on the relatively small size of the pet door and the weight restrictions of such exterior structures. In other instances, such exterior structures present obstacles to cleaning the windows, in particular, an exterior of the window due to obstruction from such exterior structures without a secondary access point.

Further, such exterior structures are generally sized and shaped to fit within inside faces of windows, particularly, sash type windows, which limits the size of the pet enclosures. For instance, such exterior structures typically have the same width as the windows in, on, or through which such exterior structures are installed. For instance, U.S. Pat. No. 4,989,546 is directed to an enclosure that is mounted to the inside face of the window. Such exterior structures are primarily supported by the window or more specifically the window sill itself, which adds extensive loads to the window frame or structure. Such exterior structures can be hazardous when, for example, unwanted animals, e.g., squirrels, chipmunks, possums, large birds of prey, etc., enter or otherwise add additional weight to the enclosures. Moreover, such exterior structures are limited in their application, in that, the available windows of a home may be narrow, and therefore limit or restrict the size and shape of such exterior structures which have to fit within the relatively narrow width of the window. In addition, such exterior structures can also limit or restrict mounting locations as such exterior structures would typically have to be supported by the inside faces of the windows.

### BRIEF SUMMARY

Embodiments described herein advantageously provide window box enclosures with robust and efficient form factors. Various embodiments described herein also advantageously provide cost savings and improve structural strength and stability of window box enclosures.

In some embodiments, a pet enclosure can be coupleable to a wall structure of a home adjacent to a window with the window providing a first access point to a pet. The pet enclosure can be summarized as including a frame structure coupled to the wall structure of the home, the frame structure having an opening which is located adjacent to the window, the frame structure including a second access point; and a corbel assembly coupled to the frame structure and the wall structure of the home.

In some embodiments, a method can include assembling a window box enclosure, the assembling including constructing a frame structure which provides a plurality of access points to a pet, coupling the window box enclosure to a wall structure of a home, and coupling a corbel assembly to the frame structure and the wall structure of the home.

### BRIEF DESCRIPTION OF THE SEVERAL VIEWS OF THE DRAWINGS

FIG. 1 is a perspective view of a window box enclosure according to one example embodiment.

FIG. 1A is a perspective view of a window box enclosure, according to one example embodiment.

FIG. 1B is a perspective view of a window box enclosure, according to one example embodiment.

FIG. 1C is a perspective view of a window box enclosure, according to one example embodiment.

FIG. 2 is an exploded view of the window box enclosure of FIG. 1, illustrating components of the window box enclosure in plan view.

FIG. 3A is a side view of an access door side panel of the window box enclosure of FIG. 1, according to one example embodiment.

FIG. 3B is a side view of a side panel of the window box enclosure of FIG. 1, according to one example embodiment.

FIG. 4A is a top plan view of a front panel of the window box enclosure of FIG. 1, according to one example embodiment.

FIG. 4B is a bottom plan view of a bottom panel of the window box enclosure of FIG. 1, according to one example embodiment.

FIG. 5A is a bottom plan view of the front panel of the window box enclosure of FIG. 1 with certain components removed for clarity, according to one example embodiment.

FIG. 5B is a side view of the top panel of the window box enclosure of FIG. 1, illustrating the top panel coupled to the side panel of the window box enclosure.

FIG. 6A is a side view of a corbel assembly of the window box enclosure of FIG. 1, according to one example embodiment.

FIG. 6B is a plan view of a plurality of corbel assemblies of the window box enclosure of FIG. 1.

FIG. 7 is a section view of a window box enclosure of FIG. 1, illustrating the window box enclosure coupled to a wall structure of a home.

FIG. 8 is a side view of the window box enclosure of FIG. 1 coupled to the wall structure of a home illustrated in FIG. 7.

FIG. 9 is a section view of a window box enclosure, according to another example embodiment, coupled to a wall structure of a home.

FIG. 10 is a side view of a window box enclosure, according to another example embodiment, coupled to a wall structure of a home.

FIG. 11 is a side view of a window box enclosure, according to another example embodiment.

FIG. 12 is a partial bottom plan view of a window box enclosure illustrating a bottom panel according to another example embodiment.

FIG. 13 is a partial section view of a window enclosure, according to another example embodiment.

FIG. 14 is a partial section view of a window box enclosure, according to another example embodiment.

FIG. 15 is a perspective view of a window box enclosure, according to another example embodiment, coupled to a wall structure of a home.

FIG. 16 is a perspective view of a window box enclosure, according to another example embodiment, coupled to a wall structure of a home.

FIG. 17 is a perspective view of a window box enclosure, according to another example embodiment, coupled to a wall structure of a home.

FIG. 18 is a perspective view of a window box enclosure, according to another example embodiment, coupled to a wall structure of a home.

FIG. 19 is a perspective view of a window box enclosure, according to another example embodiment, coupled to a wall structure of a home.

FIG. 20 is an exploded view of a window box enclosure, according to another example embodiment.

FIG. 21 is a perspective view of the window box enclosure of FIG. 20.

FIG. 22 is an exploded view of a window box enclosure, according to another example embodiment.

FIG. 23 is a perspective view of the window box enclosure of FIG. 22.

### DETAILED DESCRIPTION

In the following description, certain specific details are set forth in order to provide a thorough understanding of various disclosed embodiments. One skilled in the relevant art will recognize that embodiments may be practiced without one or more of these specific details. In other instances, well-known structures and devices associated with window box enclosures, windows, wall structures and methods to manufacture the same may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

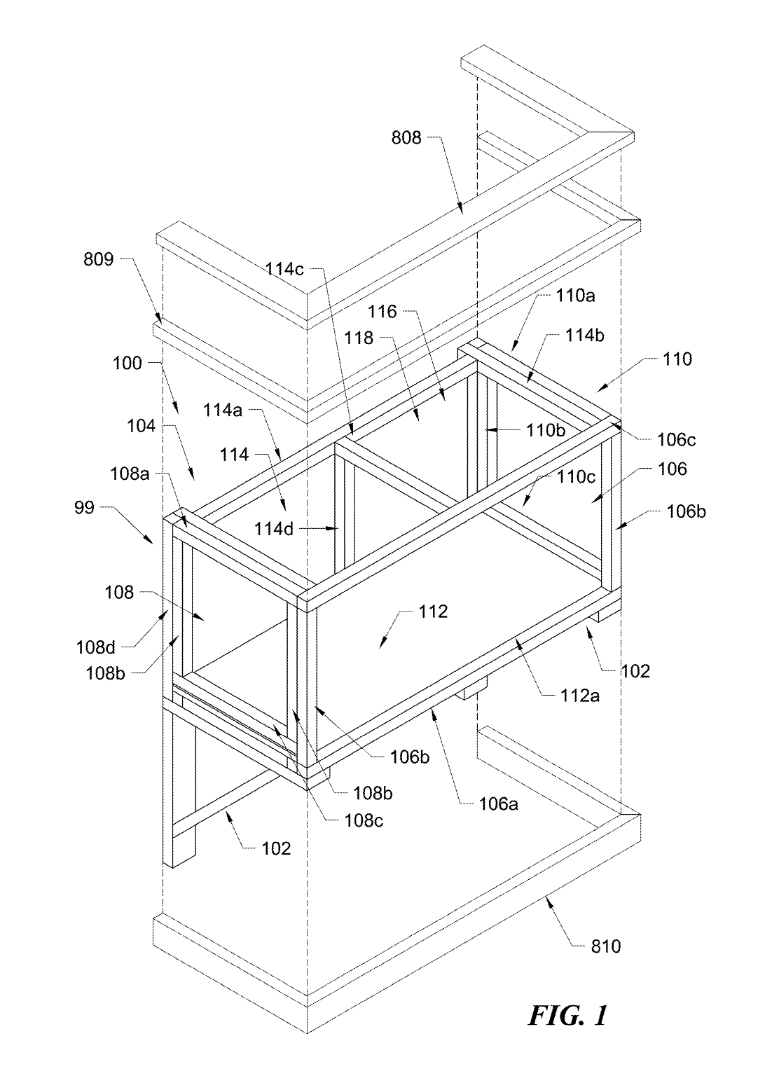

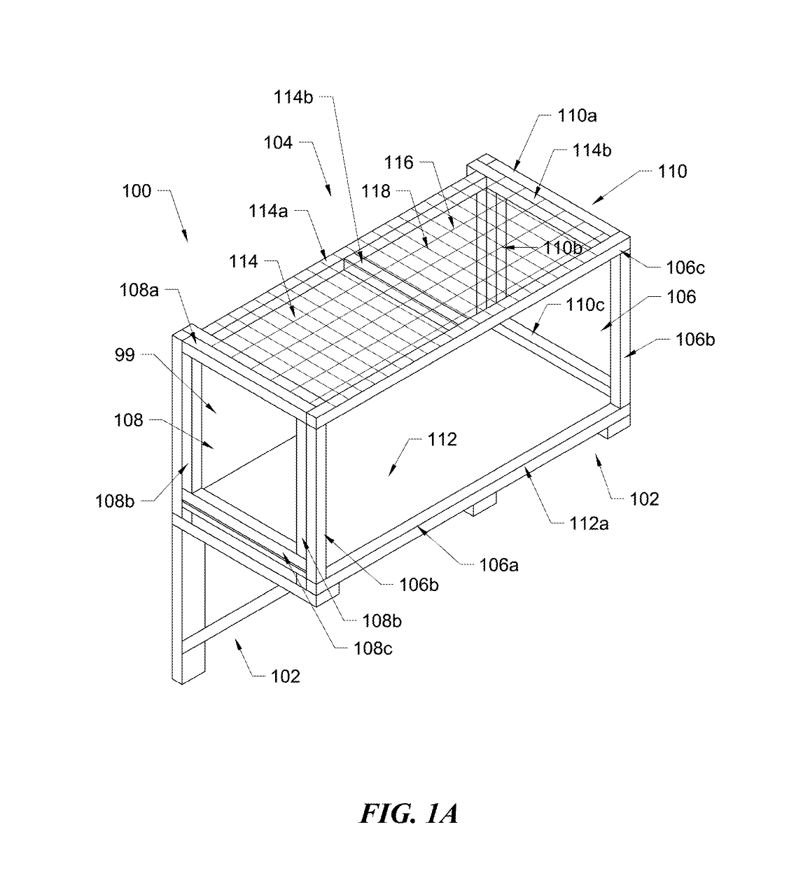

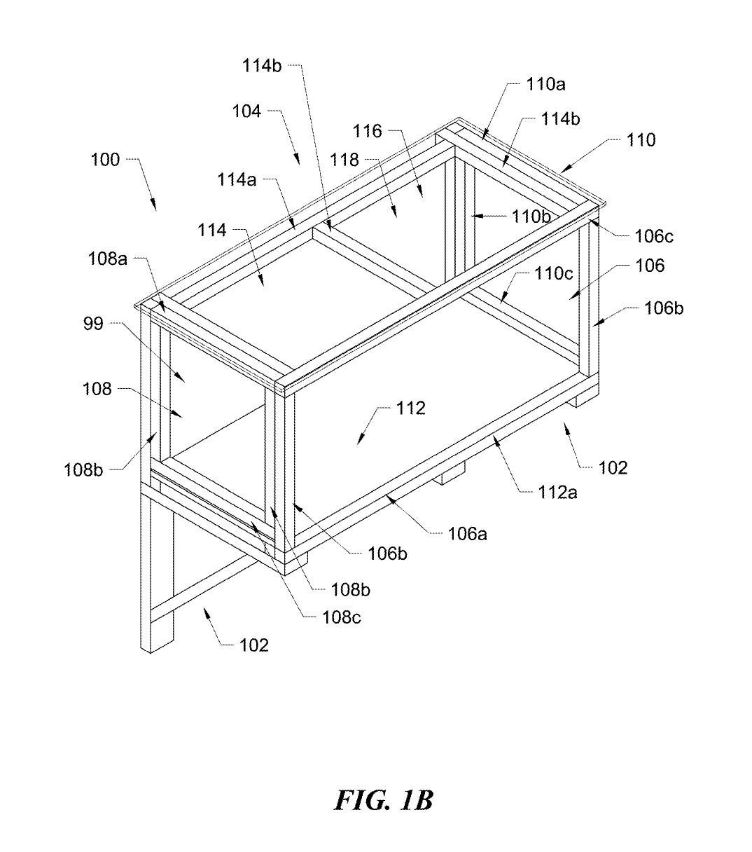

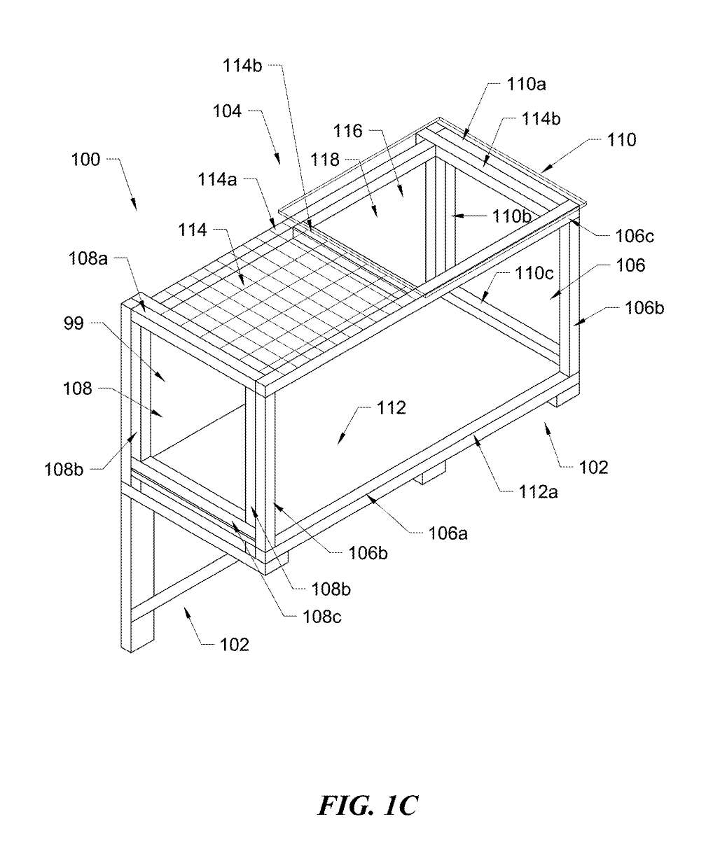

FIG. 1 illustrates a perspective view of window box enclosure 100, according to one example embodiment. The window box enclosure 100 includes a frame structure 104 where a pet, such as a cat, for example, can reside, and one or more lower support corbel assemblies 102. The frame structure 104 includes an opening 99 which provides an access point to a pet when the frame structure 104 is coupled to a window and the window is in an open configuration. The one or more lower support corbel assemblies 102 can provide support to the frame structure 104, in addition to providing decorative features or elements. In some embodiments, for example, the support corbel assembly 102 can be made from wood, metal (e.g., steel, aluminum, titanium, etc.), plastic, or various other materials. The support corbel assembly 102 can, in some embodiments, include a number of different decorative patterns cut into them to match the exterior décor of the home to which the window box enclosure 100 is coupled.

The frame structure 104 includes a plurality of panels which are coupled together to form the frame structure 104. In particular, the frame structure 104 includes a front panel 106, an access door side panel 108, a side panel 110, a bottom panel 112, and a top panel 114 with 114b top panel support. The front panel 106 includes a lower front panel element 106a, a pair of side front panel elements 106b, and an upper front panel element 106c. The lower front panel element 106a, the pair of side front panel elements 106b, and the upper front panel element 106c are coupled together to form the front panel 106, via fasteners, adhesives, welding, or other coupling structures. In some embodiments, however, the lower front panel element 106a, the pair of side front panel elements 106b, and the upper front panel element 106c can be integrally formed, for example, machined, carved, etc.

The access door side panel 108, which can be interchangeable with the side panel 110, includes an upper access door panel element 108a, side access door panel elements 108b, and a lower access door panel element 108c. The upper access door panel element 108a, the side access door panel elements 108b, and the lower access door panel element 108c are coupled together to form the access door side panel 108, via fasteners, adhesives, welding, or other coupling structures. In some embodiments, however, the upper access door panel element 108a, the side access door panel elements 108b, and the lower access door panel element 108c can be integrally formed, for example, machined, carved, etc.

The side panel 110 includes an upper side panel element 110a, side panel elements 110b, and a lower side panel element 110c. The upper side panel element 110a, side panel elements 110b, and the lower side panel element 110c are coupled together to form the side panel 110, via fasteners, adhesives, welding, or other coupling structures. In some embodiments, however, the upper side panel element 110a, side panel elements 110b, and the lower side panel element 110c can be integrally formed, for example, machined, carved, etc.

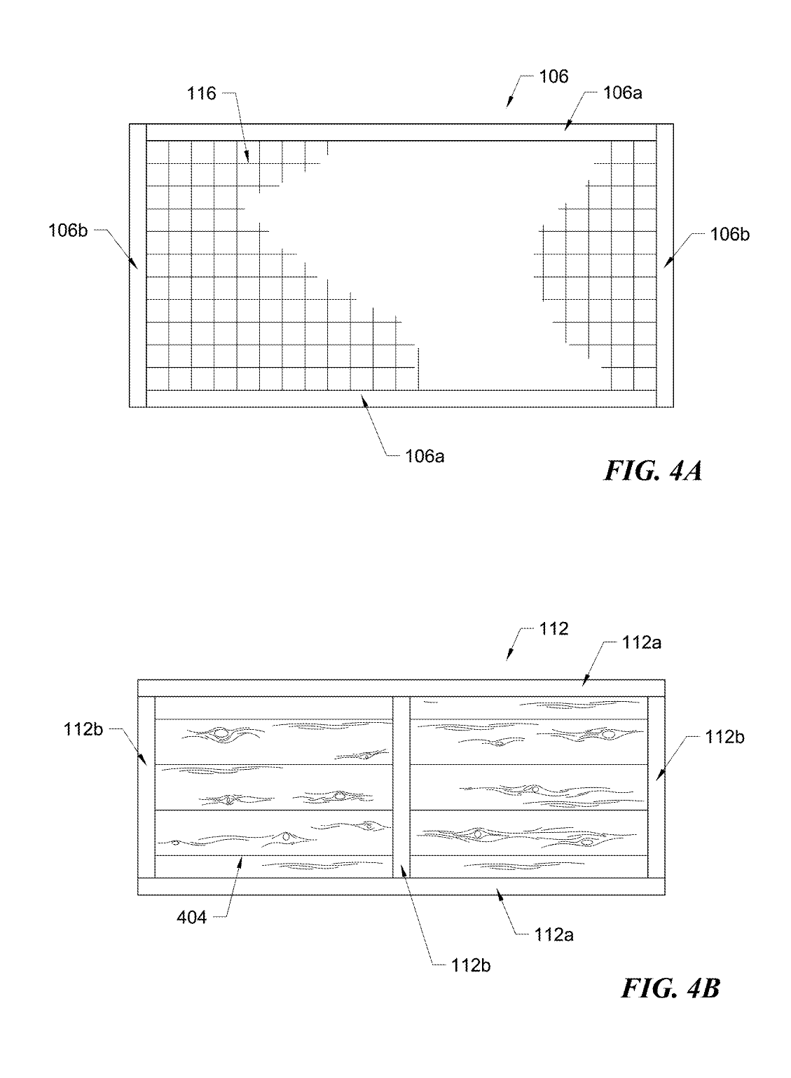

The bottom panel 112 includes a pair of lateral bottom panel elements 112a (FIG. 4B) and a plurality of side bottom panel elements 112b (FIG. 4B) which can be equally or unequally spaced apart relative to each other. The pair of lateral bottom panel elements 112a and the side bottom panel elements 112b are coupled together to form the bottom panel 112, via fasteners, adhesives, welding, or other coupling structures. In some embodiments, however, the pair of lateral bottom panel elements 112a and the side bottom panel elements 112b can be integrally formed, for example, machined, carved, etc.

The top panel 114 includes a lateral top panel element 114a, a pair of side top panel elements 114b, and a center top panel element 114c, and vertical support element 114d, which can be equally or unequally spaced apart relative to each other. The lateral top panel element 114a, the side top panel elements 114b, and the center top panel element 114c, and vertical support element 114d are coupled together to form the top panel 114, via fasteners, adhesives, welding, or other coupling structures. In some embodiments, however, the lateral top panel element 114a, the side top panel elements 114b, the center top panel element 114c, and the vertical support element 114d can be integrally formed, for example, machined, carved, etc.

In some embodiments, the panels (i.e., front panel 106, access door side panel 108, side panel 110, bottom panel 112, top panel 114, etc.) can advantageously be pre-assembled which can facilitate ease of assembling the frame structure 104. In other embodiments, the panels (i.e., front panel 106, access door side panel 108, side panel 110, bottom panel 112, top panel 114, etc.) and assembly components, such as, panel elements, fasteners, hinges, brackets, etc., can be assembled at a work site.

In some embodiments, the panels (i.e., front panel 106, access door side panel 108, side panel 110, bottom panel 112, top panel 114, etc.) can include additional decorative elements including, but not limited to, metal, wood or décor to enhance the aesthetics of the window box enclosure 100.

With continued reference to FIG. 1, the window box enclosure 100 also includes a top trim element 808 and a lower trim element 809 coupled to the top trim element 808. The top trim element 808 coupled to the lower trim element 809 are advantageously sized and shaped to conceal a top covered roofing material, a wire mesh, or any other roof material that is coupled to a top panel 114 (FIGS. 1A-1C), such as those discussed in greater detail below. In particular, the top trim element 808, in some embodiments, forms a u-shaped structure; for example, the top trim element 808 can include a horizontal element extending between a pair of parallel side elements, which form a periphery of the top trim element 808 and define an opening to partially cover and/or seat the top covered roofing material, wire mesh, or other roof structure. The lower trim element 809 also forms a u-shaped structure and includes a horizontal element and pair of parallel side elements, which form a periphery of the lower trim element 809. The lower trim element 809 is coupled to the top trim element 808, front panel 106, access door side panel 108, and the side panel 110. The top trim element 808 is coupled to the lower trim element 809 and is positioned above the lower trim element 809 or adjacent to the outer edge of top trim element 808. When the lower trim element 809 is coupled to the top trim 808 element, the peripheries of the top trim element 808 and the lower trim element 809 extend beyond a periphery of the top panel 114, which allows the top covered roofing material, wire mesh, or other roof structure to be concealed or hidden when viewed from front or side perspectives of the window box enclosure 100. In this manner, the window box enclosure 100 can provide an aesthetically pleasing view to pet owners.

The window box enclosure also includes a bottom trim element 810. The bottom trim element 810, in some embodiments, forms a u-shaped structure; for example, the bottom trim element 810 can include a horizontal element extending between a pair of parallel side elements, which form a periphery of the bottom trim element 810. The bottom trim element 810 is coupled to the bottom panel 112. Again, the bottom trim element 810 advantageously conceals or hides various portions of the frame structure 104, including the floor portions and portions of the one or more corbel 102 assemblies to provide an aesthetically pleasing view to pet owners.

FIG. 1a-1c illustrate various embodiments of the window box enclosures, with certain components removed for clarity of illustration and description. FIG. 1A illustrates an embodiment of a window box enclosure 100 which includes a wire mesh 116 coupled to an outer periphery of an inner face of a portion of the adjacent panel and top panel 114. The wire mesh 116 can be coupled via fasteners, staples, welding, or other coupling structures. FIG. 1B illustrates an embodiment of a window box enclosure 100 which includes a top frame covered roofing material 118 coupled to an outer periphery of an inner face of a portion of the adjacent panel via fasteners, staples, welding, or other coupling structures. FIG. 1C illustrates an embodiment of a window box enclosure 100 which includes a partial covered roofing material 118 and a partial wire mesh 116, which both are coupled to an outer periphery of an inner face of a portion of an adjacent panel. Again, the partial covered roofing material 118 and the partial wire mesh 116 can be coupled to an outer periphery of an inner face of an adjacent panel via fasteners, staples, welding, or other coupling structures

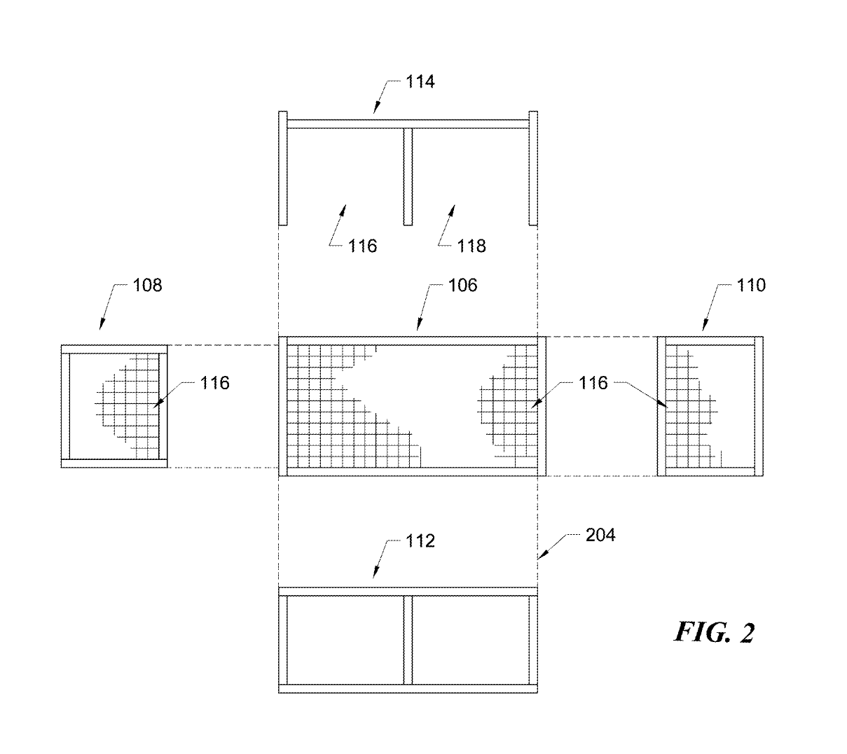

FIG. 2 illustrates an exploded view of the frame structure 104 illustrating the panels (i.e., front panel 106, access door side panel 108, side panel 110, bottom panel 112, top panel 114, etc.) of the frame structure 104 in plan view. As shown in FIGS. 1, 1a-1c, and 2, in some embodiments, the front panel 106, the access door side panel 108, and the side panel 110 can each include a wire mesh 116 which is coupled to an outer periphery of an inner face of a respective panel via fasteners, staples, welding, or other coupling structures. In some embodiments, the bottom panel 112 can include a wire mesh 116. Alternatively the wire mesh 116 can, in some embodiments, be omitted. In some embodiments, the top panel 114 can include a wire mesh 116 and, in other embodiments, the top panel 114 can include a top covered roofing material 118 in lieu of the wire mesh 116. For example, the top covered roofing material 118 can advantageously be a solid structure to prevent rain, snow, hail, or other inclement weather elements from penetrating the window box enclosure 100. The covered roofing material 118 can be relatively planar and flat which can reduce manufacturing costs associated with complex roof structures which require specific positioning and drainage capabilities. In such embodiments, the top covered roofing material 118 can be selectively positioned below overhanging eaves of homes which facilitate drainage of rain water, for example, and thus avoid costly roof structures of typical pet enclosures requiring drainage capabilities. Further, in some embodiments, the top covered roofing material 118 having an angular structure beneath is also within the spirit and scope of the disclosed subject matter.

In some embodiments, top covered roofing material 118 can comprise polycarbonate or other plastic material, metal, or other suitable materials. In some embodiments, the top panel 114 can include a combination of the top covered roofing material 118 and the wire mesh 116. In some embodiments, the top panel 114 can be configured to removably receive the wire mesh 116 or the top covered roofing material 118, which can allow a user to switch between the top covered roofing material 118 and the wire mesh 116 based on the weather conditions. In some embodiments, window box enclosure 100 can include the top covered roofing material 118 slideably coupled to the top panel 114 and positioned adjacent the wire mesh 116 coupled to the top panel 114. In this manner, the top frame element 118 can be alternated between open and closed configurations to provide access to sunlight and protection during inclement weather.

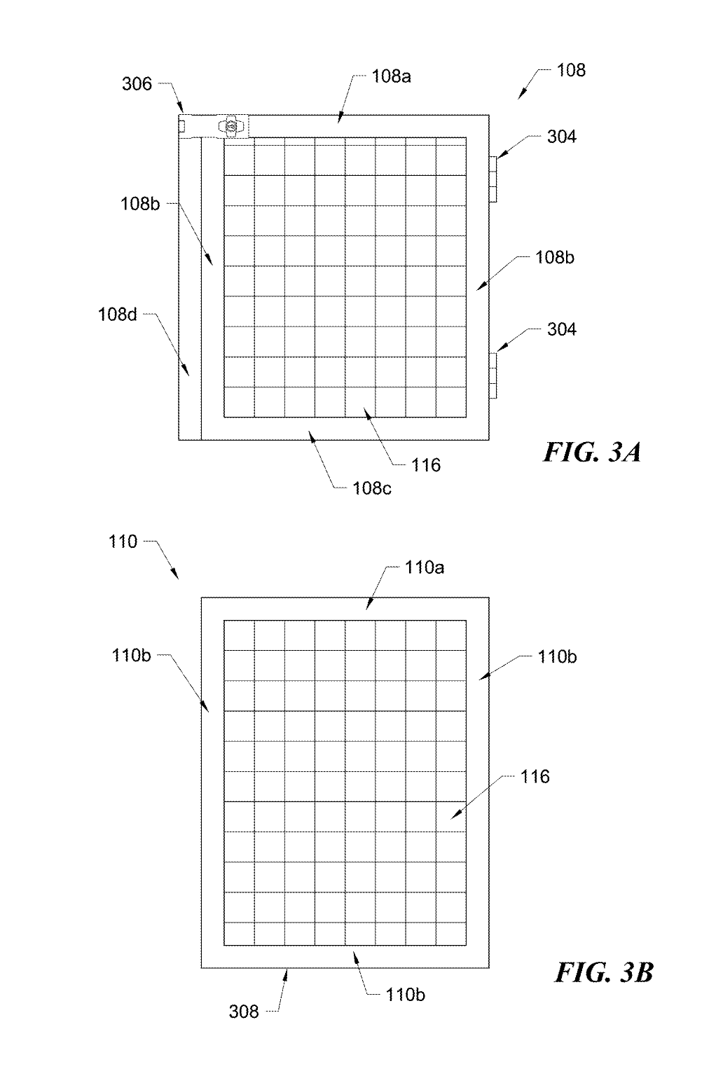

FIGS. 3a and 3b illustrate a plan view of the side access door panel 108 and the side panel 110, respectively. As illustrated in FIG. 3A, the side access door panel 108 includes a hinge 304 which hingedly couples the access door side panel 108 to the frame structure 104, particularly, the front panel 106 or a vertical door support 108d. In this manner, the access door side panel 108 can pivotably rotate between open and closed configurations. In some embodiments, however, the access door side panel 108 can be hingedly coupled to other components of the frame structure 104, such as the top panel 114, the bottom panel 112, etc. While the side panel 110 illustrated in FIG. 3B does not include a hinge 304, in some embodiments, the side panel 110 can also include the hinge 304 to hingedly couple the side panel 110 to the frame structure 104. More particularly, the access side door panel 108 and, in embodiments where the side panel 110 is hingedly coupled to the frame structure 104, the window box enclosure 100 can include a plurality of additional access points to a pet in the window box enclosure 100, in addition to the access point provided by the window. Further, in some embodiments, the front panel 106 can also be hingedly coupled to the frame structure 104 to provide an additional access point. As shown in FIG. 3B, the side access door panel 108 also includes a locking device 306, such as a locking hasp, located on an opposite end of the side access door side panel 108 relative to an end of the access door side panel 108 which receives the hinge 304. The locking device 306 can securely lock the side access door side panel 108. In addition, in some embodiments, the location of hinge 304 and locking device 306 can be interchangeable.

FIGS. 4A and 4B illustrate a plan view of the front panel 106 and the bottom panel 112, respectively. As discussed above, the front panel 106 includes the wire mesh 116 coupled to the outer periphery of an inner face of the front panel 106. Further, as discussed above, in some embodiments, the front panel 106 can also include the hinge 304 to allow the front panel 106 to pivotably alternate between an open and a closed configurations. In this manner, the front panel 106 can also provide an additional access point to the window box enclosure 100. The bottom panel 112 includes a support structure 404. In some embodiments, including the bottom panel 112 of FIG. 4B, the support structure 404 can comprise one or more floor planks or other rigid structure coupled to the pair of lateral bottom panel elements 112a and the plurality of side bottom panel elements 112b. In some embodiments, the one or more floor planks of the support structure 404 can comprise any type of wood, such as cedar, plywood, metal pan, plastic, such as polycarbonate, or any other suitable material which can support the weight of the pet without excessive deflections and/or deformation. Further, in some embodiments, the bottom panel 112, for example, the support structure 404, can also include an access panel portion. The access panel portion can be hingedly coupled to the support structure 404, moveably coupled to the support structure 404, or removably coupled to the support structure 404.

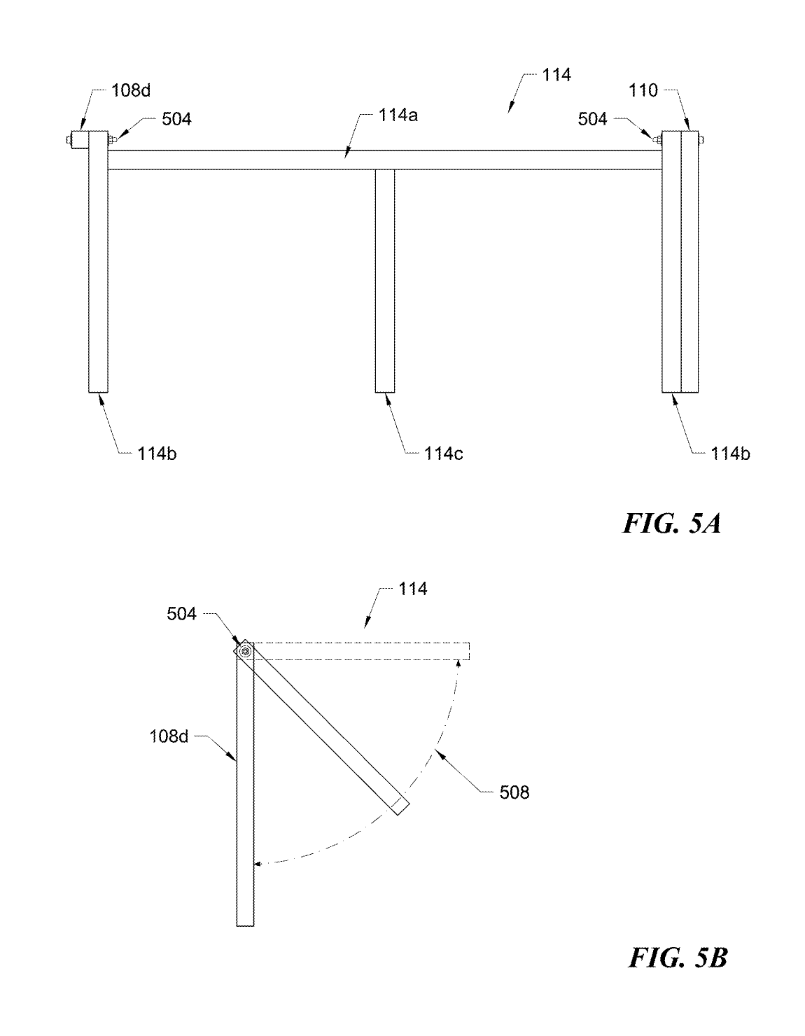

FIG. 5A illustrates a plan view of the top panel 114 and FIG. 5B illustrates a partial side view of the top panel 114 showing pivotal movement of a portion of the top panel 114. As discussed in more detail above, the top panel 114 includes the lateral top panel element 114a and the plurality of side top panel elements 114b which can be equally or unequally spaced apart relative to each other. The top panel 114 includes a rotation mechanism, e.g., fastening system 504, which rotatably couples ends of the top panel 114 to the corresponding side access door panel 108, side panel 110 and the vertical door support 108d. As illustrated in more detail in FIG. 5B, the top panel 114 can pivot off a pivot axis defined by the fastening system 504 to move between a closed configuration and an open configuration along a rotation path 508. In this manner, the window box enclosure 100 facilitates ease of installation and storage by allowing the top panel 114 to close or open when required.

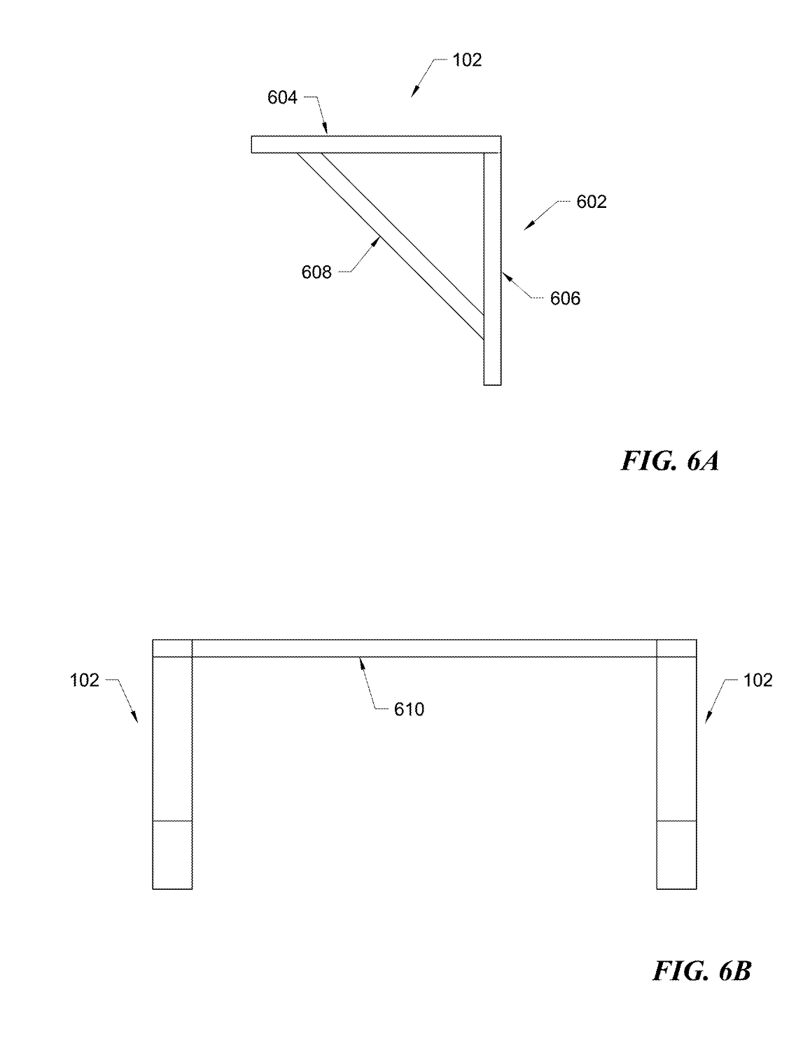

FIG. 6A illustrates the support corbel assembly 102 according to one example embodiment. FIG. 6B illustrates a pair of corbel assemblies 102 coupled to and spaced apart relative to each other via a width spacer 610. The support corbel assembly 102 includes a top horizontal member 604, a back vertical member 606 and an angled brace member 608. The top horizontal member 604, the back vertical member 606 and the angled brace member 608 can comprise wood, metal, or any other suitable material. The top horizontal member 604, the back vertical member 606, and the angled brace member 608 are coupled to each other via fasteners, welding, adhesion, or other suitable coupling structures. In some embodiments, however, the top horizontal member 604, the back vertical member 606 and the angled brace member 608 can be integrally formed, for example, machined, carved, etc. Although not shown, in some embodiments, the window box enclosure 100 can also include an “L” brace in addition to the corbel assembly 102. The support corbel assembly 102 can include various decorative features, such as a curved angle brace, routered edges on each member, carved patterns, etc.

With reference to FIGS. 1 and 6A-6B, the support corbel assembly 102 is coupled to the frame structure 104 and an exterior wall of a home to provide structural stability and support. Further, the window box enclosure 100 can include one or more corbel assemblies 102 where the one or more corbel assemblies 102 can be spaced apart via the width spacer 610. The one or more corbel assemblies 102 can be sized and shaped to provide adequate structure stability to avoid supporting the window box enclosure 100 on or by the window, for example, an inside face of a window sill. The structural support and stability provided by one or more corbel assemblies 102 can also allow the window box enclosure 100 to have a wide variety of widths, such that the width of the window box enclosure 100 can extend beyond the width of the window.

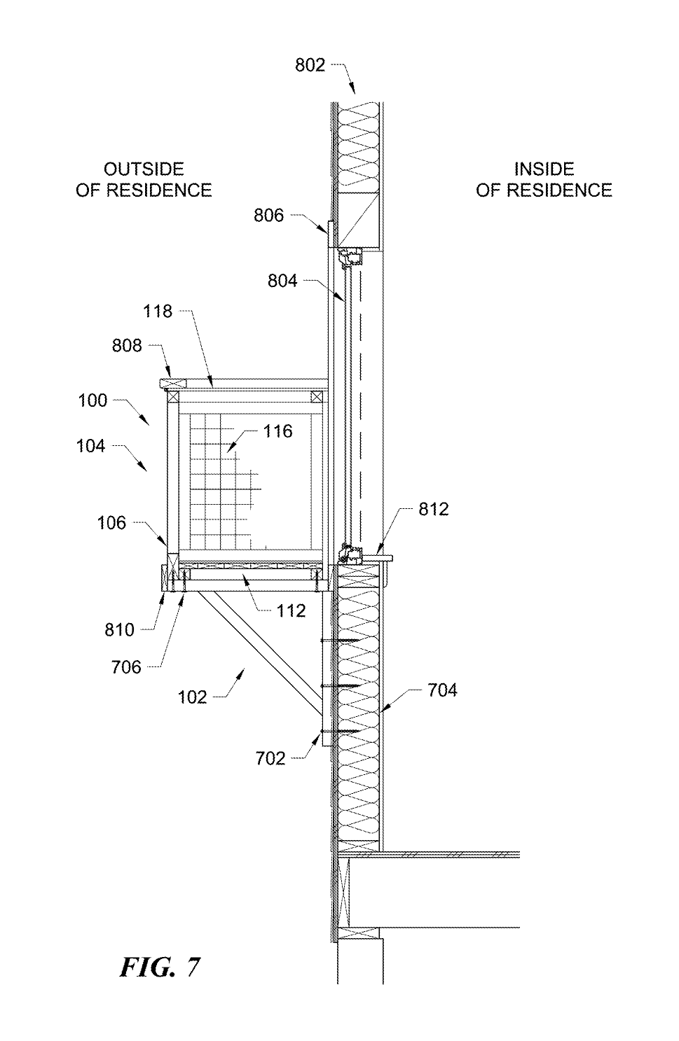

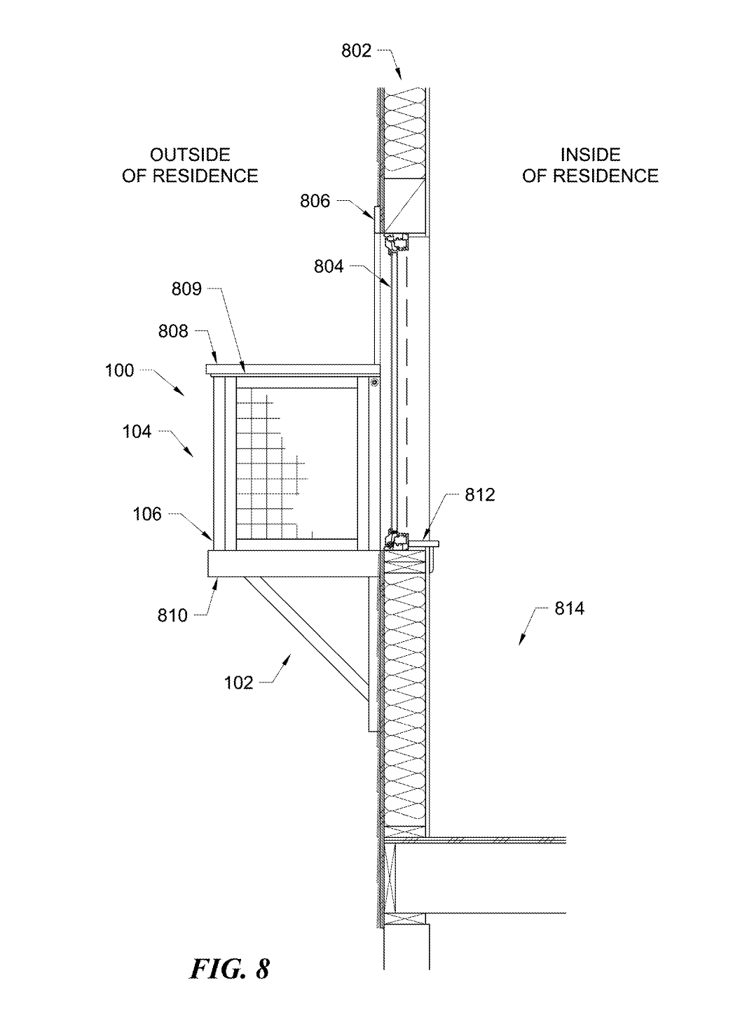

FIGS. 7-8 illustrate various views of the window box enclosure 100 coupled to an exterior wall 802 of a home. As shown in FIGS. 7-8, each support corbel assembly 102 is coupled to a framing member 704 of the exterior wall 802 of the home with fasteners 702, e.g., lag type bolts, coupling the one or more corbel assemblies 102 to the framing member 704. After the one or more corbel assemblies 102 are coupled to the framing member 704 of the exterior wall 802 of the home, the frame structure 104 can be positioned or set on the one or more corbel assemblies 102 and coupled thereto. For instance, in some embodiments, the top horizontal member 604 of the one or more corbel assemblies 102 is coupled to the front panel 106 and the bottom panel 112 via coupling panel fasteners 706, e.g., lag type bolts.

As illustrated in FIGS. 7-8, the window box enclosure 100 is positioned adjacent to an exterior window 804 of a home, the window 804 having an exterior window trim 806 and an interior window sill 812. In particular, the window box enclosure 100 is positioned such that the opening 99 of the window box enclosure 100 faces the exterior window 804. In this manner, a pet, such as a cat can step on the interior window sill 812 and access the window box enclosure 100 via the opening 99 when the window is in an open configuration. The window box enclosure 100 can also include a top frame covered roofing material 118 or wire mesh 116 disposed above the top panel 114 and a lower trim element 809 disposed adjacent the top panel 114. The window box enclosure 100 can also include the bottom trim element 810 mounted adjacent to the bottom panel 112.

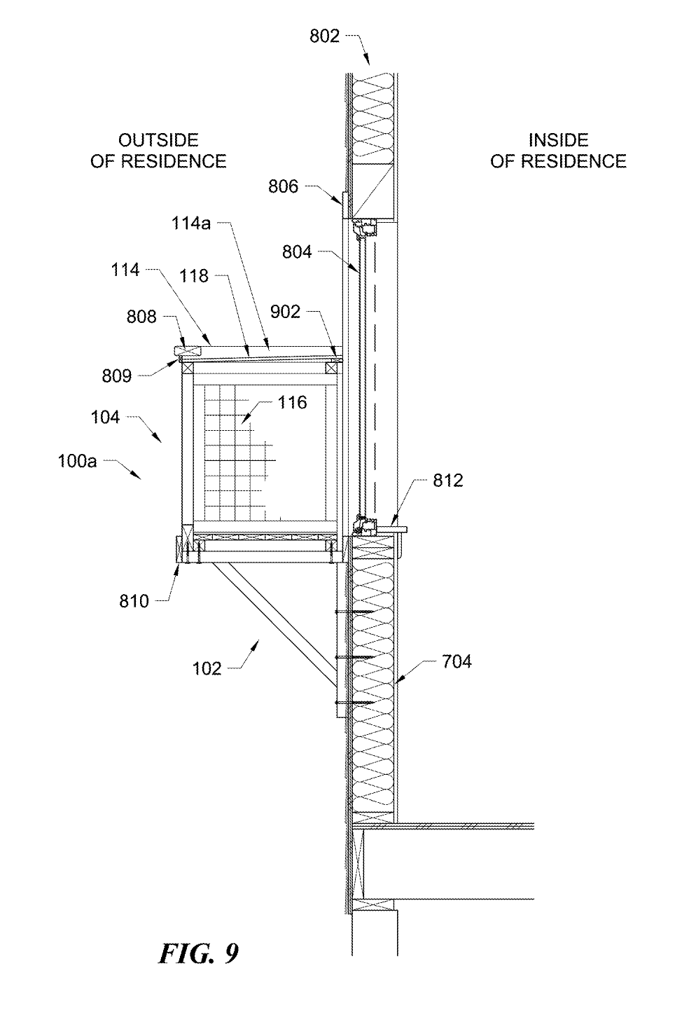

FIGS. 9 through 22 illustrate various embodiments of the window box enclosures. In general, unless stated otherwise or evident from the context, or description or the illustrations, the window box enclosures and the components thereof are generally similar to those described above, and have not been described in detail for the sake of clarity of description and illustration.

FIG. 9 illustrates a window box enclosure 100a according to another embodiment coupled to the exterior wall 802 of a home. In this variation, the top panel 114 of the window box enclosure 100a can include a roof shim 902 disposed between the lateral top panel element 114a and the top frame covered roofing material 118 to define a sloped configuration of the top panel 114. In this manner, the window box enclosure 100a can facilitate disposing or running off water collected on the window box enclosure 100a. In some embodiments, to cover a gap created between the top covered roofing material 118 and the lateral top panel element 114a, the lower trim element 809 can be provided below the top trim element 808.

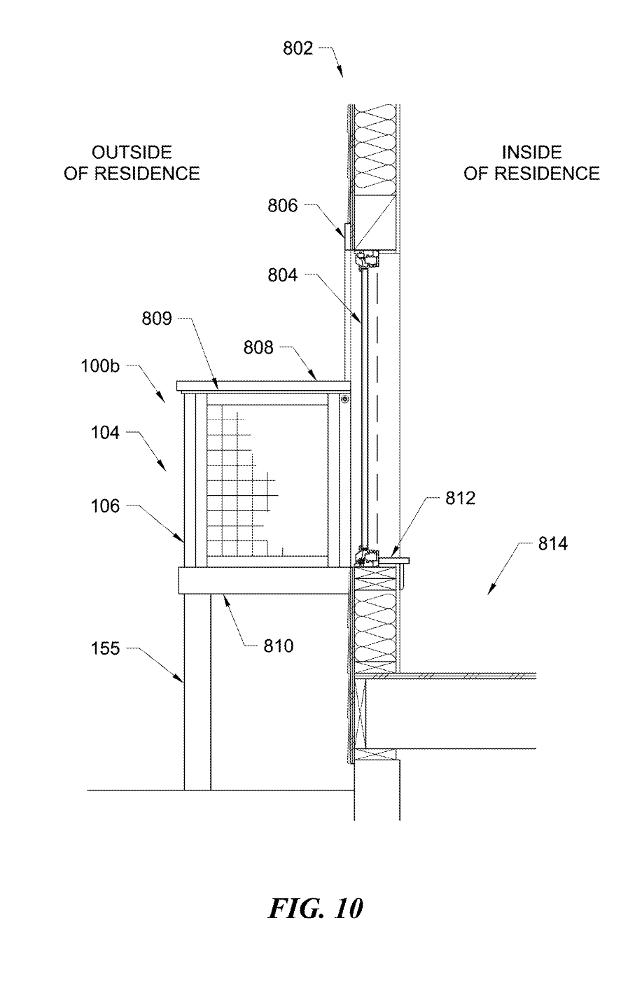

FIG. 10 illustrates a window box enclosure 100b according to another embodiment coupled to the exterior wall 802 of a home. In this variation, the frame structure 104 is coupled to one or more legs 155 which extend from the frame structure 104 to and through a ground structure. In some embodiments, as shown in FIG. 10, the legs 155 can provide support to the frame structure 104 in lieu of the corbel assemblies 102. In some embodiments, the legs 155 can provide support to the frame structure 155 in addition to corbel assemblies 102.

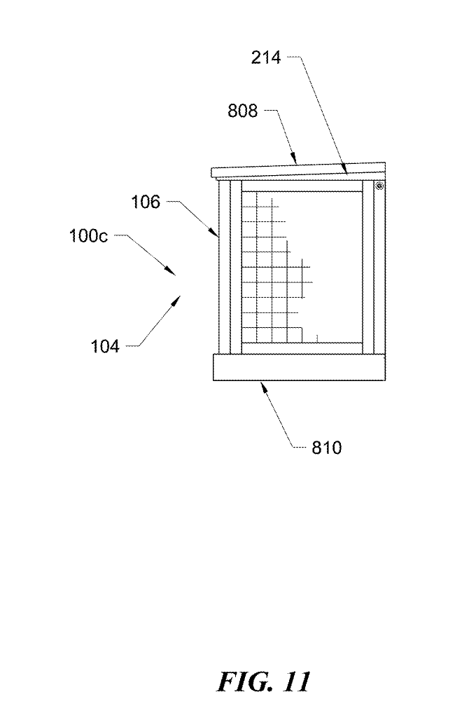

FIG. 11 illustrates a window box enclosure 100c according to another embodiment. In this variation, the frame structure 104 includes a first top panel roofing material 214 which tapers toward the front panel 106 to provide an angular configuration of a roof structure. Although not shown, the first panel roofing material 214 coupleably receives the top frame covered roofing material 118. In some embodiments, the frame structure 104 can also include side panels (e.g., side access door panel 108, side panel 110) where the adjacent and opposing side panel elements of each side panel can have differing heights to provide an angular configuration of a roof structure. For instance, the side panel elements which are positioned proximal to the wall structure of a home can have a larger height than the adjacent and opposing side panel elements which are distal to the wall structure of a home. In this manner, the window box enclosure can also have an angular roof structure.

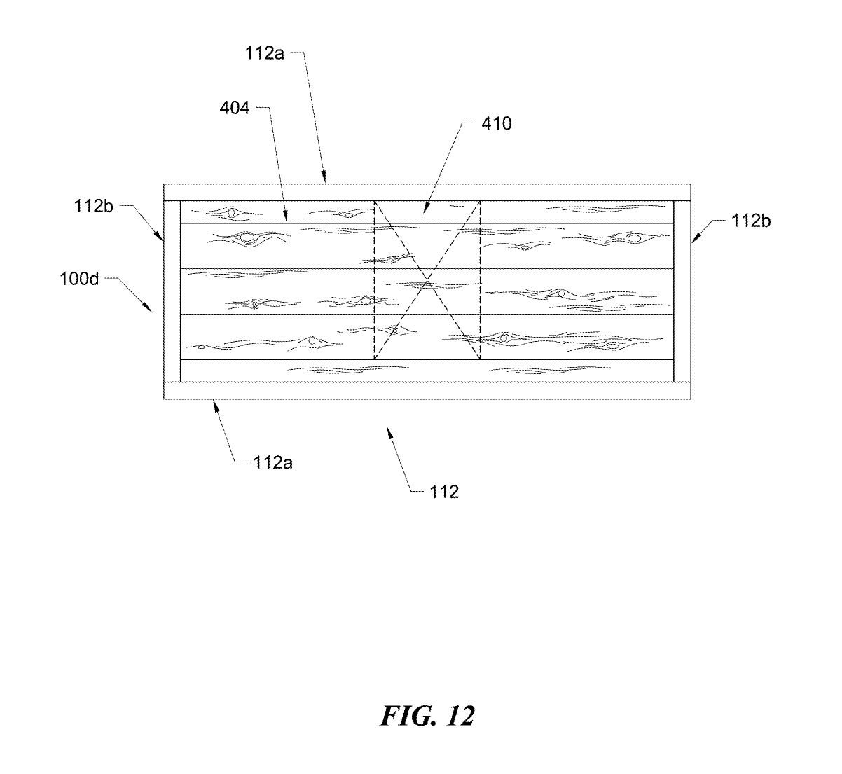

FIG. 12 partially illustrates a window box enclosure 100d with certain components removed for clarity of description and illustration. In particular, in this variation, the window box enclosure 100d includes a bottom panel 112 according to another example embodiment. The bottom panel 112 includes a support structure 404 and a bottom access portion 410. The bottom access portion 410 is removably coupled to the support structure 404 to provide an additional access point to the window box enclosure 100d. The bottom access portion 410 is positioned above the pair of lateral bottom panel elements (e.g., bottom panel elements 112a) and the plurality of side bottom panel elements (e.g., side bottom panel elements 112b) via cleats positioned underneath. The bottom access portion 410 can be lifted up to provide access to the interior of the window box enclosure 100d. In some embodiments, the bottom access portion 410 can also be hingedly coupled to the support structure 404. Further, in some embodiments, the bottom access portion 410 can also be slideably coupled to the support structure 404, for example, via a track mechanism.

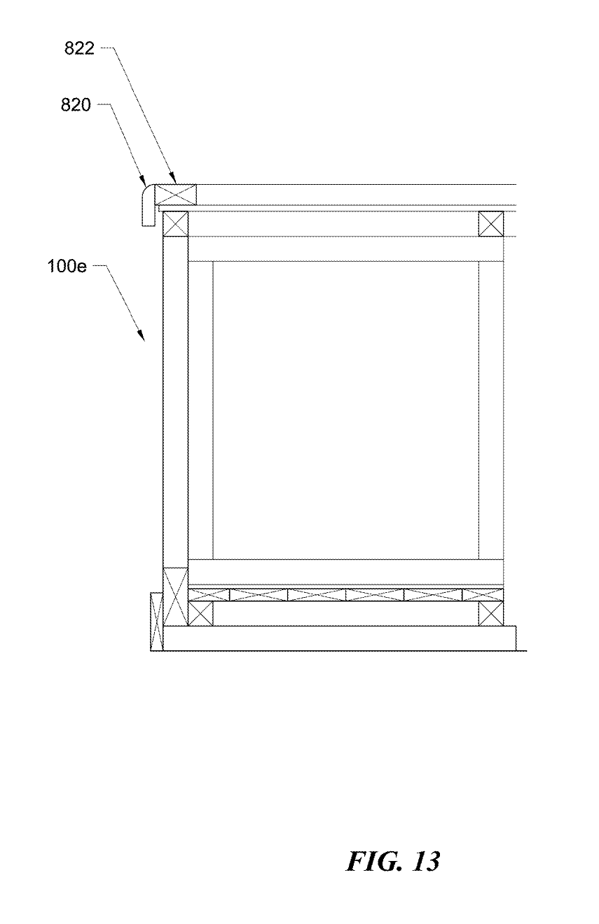

FIG. 13 illustrates a window box enclosure 100e according to another example embodiment. The window box enclosure 100e provides a variation in which the window box enclosure 100e includes a cove vertical trim 820 in lieu of the lower trim element 809. The cove vertical trim 820 is coupled to a side face of the top trim element, e.g., top trim element 822. Again, the cove vertical element 820 along with the top trim element 822 conceal or hide the top covered roof material, wire mesh, or other roof structure when viewed from a front or side perspectives of the window box enclosure 100e.

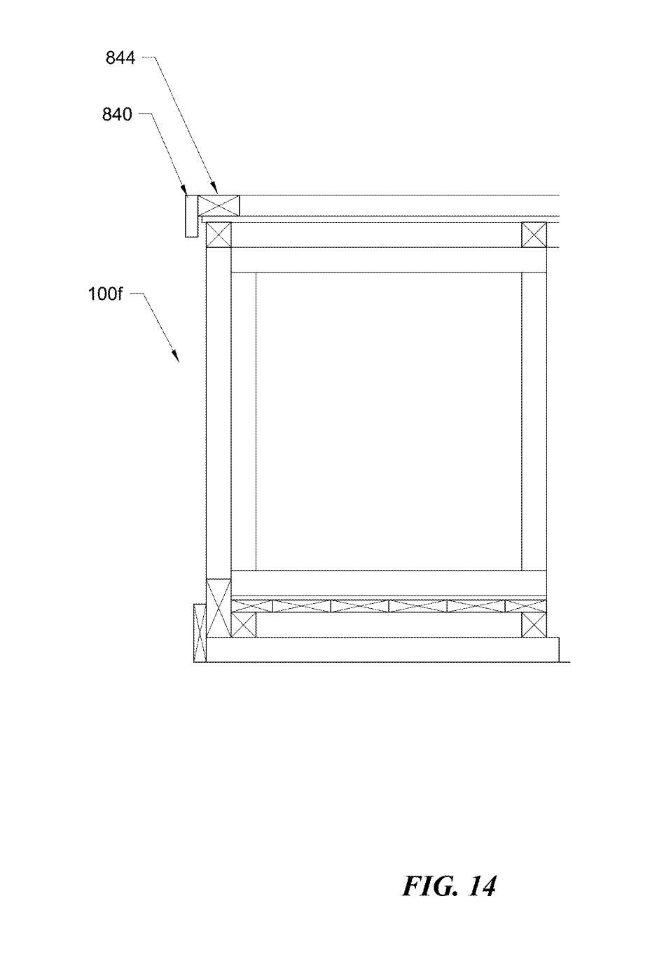

FIG. 14 illustrates a window box enclosure 100f according to another example embodiment. The window box enclosure 100f provides a variation in which the window box enclosure 100f includes a square vertical trim 840 in lieu of the lower trim element 809. The square vertical trim 840 is coupled to a side face of the top trim element, e.g., top trim element 844. Again, the square vertical element 840 along with the top trim element 844 conceal or hide the top covered roof material, wire mesh, or other roof structure when viewed from a front or side perspectives of the window box enclosure 100f.

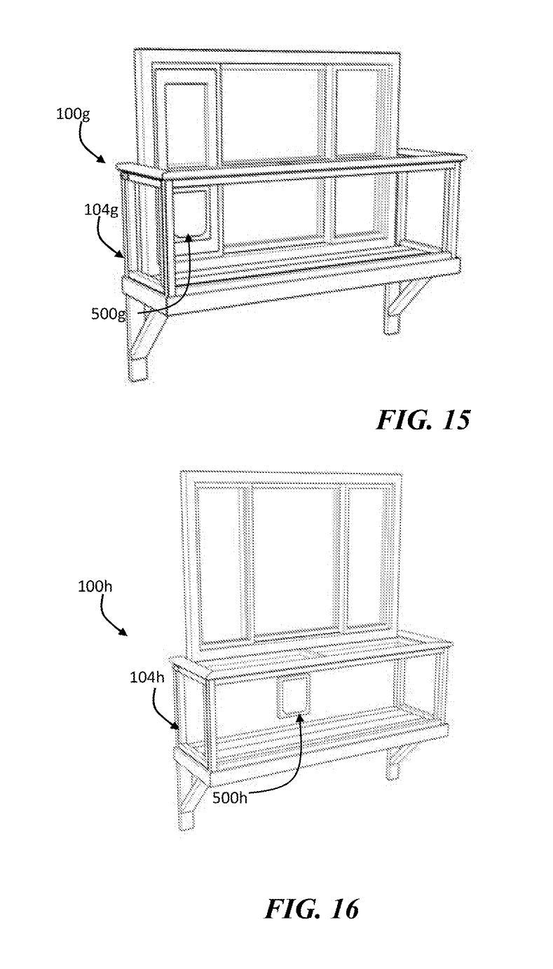

FIGS. 15-19 illustrate various exemplary embodiments of window box enclosures 100g-k coupled to an exterior wall of a home adjacent to a window. As shown in FIGS. 15-19, the window box enclosures 100g-k can advantageously be coupled to sash windows, sliding windows, and can also be coupled to the exterior walls in a manner where the window box enclosures 100g-k are not supported by the window frames.

FIG. 15 illustrates a window box enclosure 100g which includes a frame structure 104g. The frame structure 104g is sized and shaped to extend beyond the periphery of the sliding window. In addition, in some embodiments, an access door 500e may be disposed in the window which can provide an additional access point to the window box enclosure 100g for the pet.

FIG. 16 illustrates a window box enclosure 100h which includes a frame structure 104h. The frame structure 104h is coupled to the exterior wall and is positioned below a sliding window. Again, the frame structure 104h is sized and shaped to extend beyond the periphery of the sliding window. In addition, in some embodiments, an access door 500h may be disposed in the exterior wall which can provide an access point to the window box enclosure 100h for the pet.

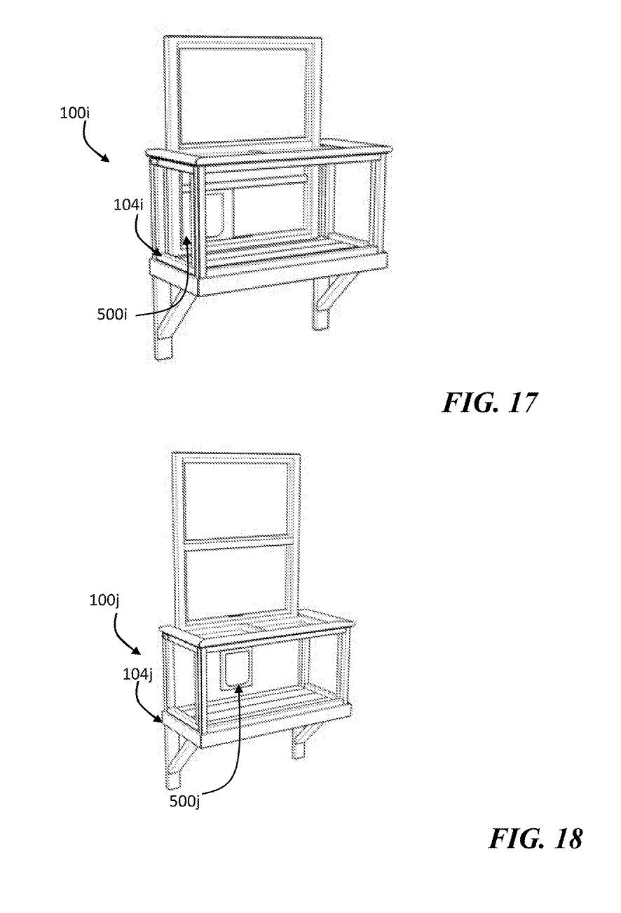

FIG. 17 illustrates a window box enclosure 100i which includes a frame structure 104i. The frame structure 104i is coupled to the exterior wall and is sized and shaped to extend beyond the periphery of a sash window. In addition, in some embodiments, an access door 500i may be disposed in the sash window which can provide an access point to the window box enclosure 100i for the pet.

FIG. 18 illustrates a window box enclosure 100j which includes a frame structure 104j. The frame structure 104j is coupled to the exterior wall and is positioned below a sash window. Again, the frame structure 104j is sized and shaped to extend beyond the periphery of the sash window. In addition, in some embodiments, an access door 500j may be disposed in the exterior wall which can provide an access point to the window box enclosure 100j for the pet.

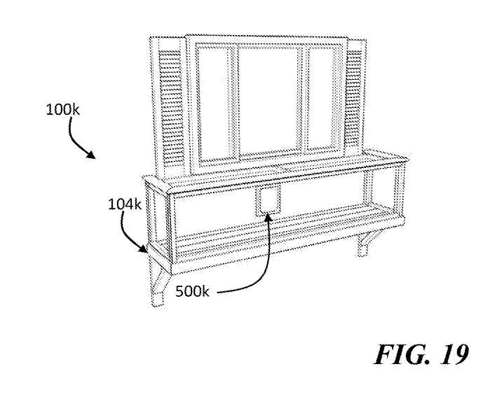

FIG. 19 illustrates a window box enclosure 100k which includes a frame structure 104k. The frame structure 104k is coupled to the exterior wall and is sized and shaped to extend beyond a periphery of a sliding window and a pair of louvres, wherein each louvre is positioned adjacent the sliding window. In addition, in some embodiments, an access door 500k may be disposed in the exterior wall which can provide an access point to the window box enclosure 100k for the pet.

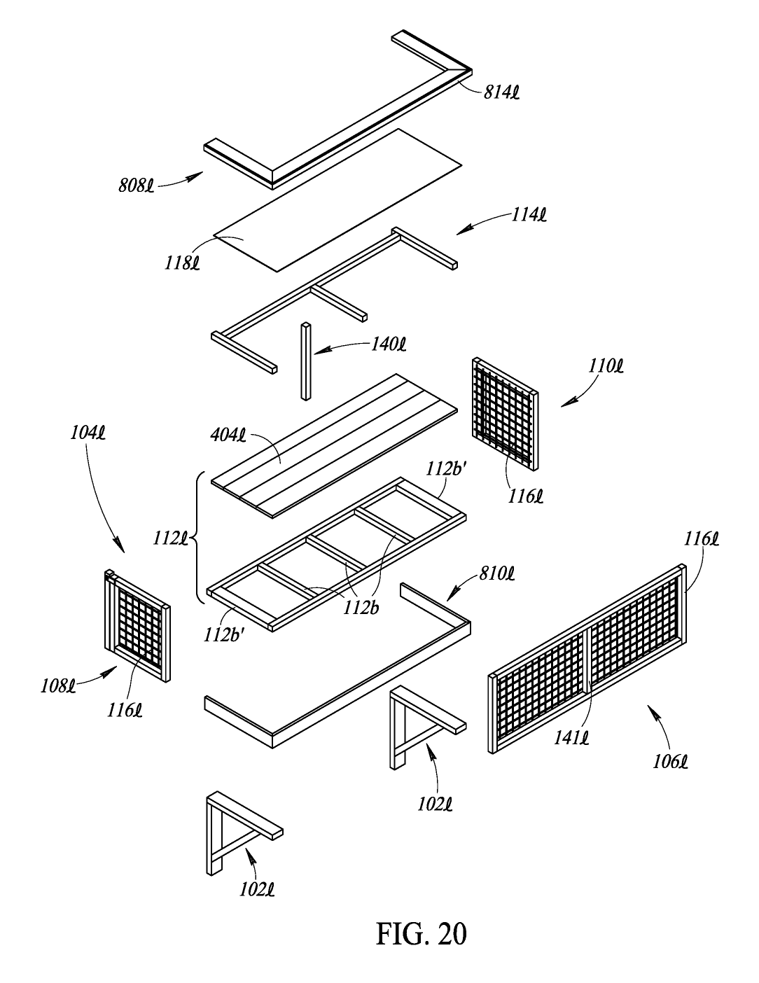

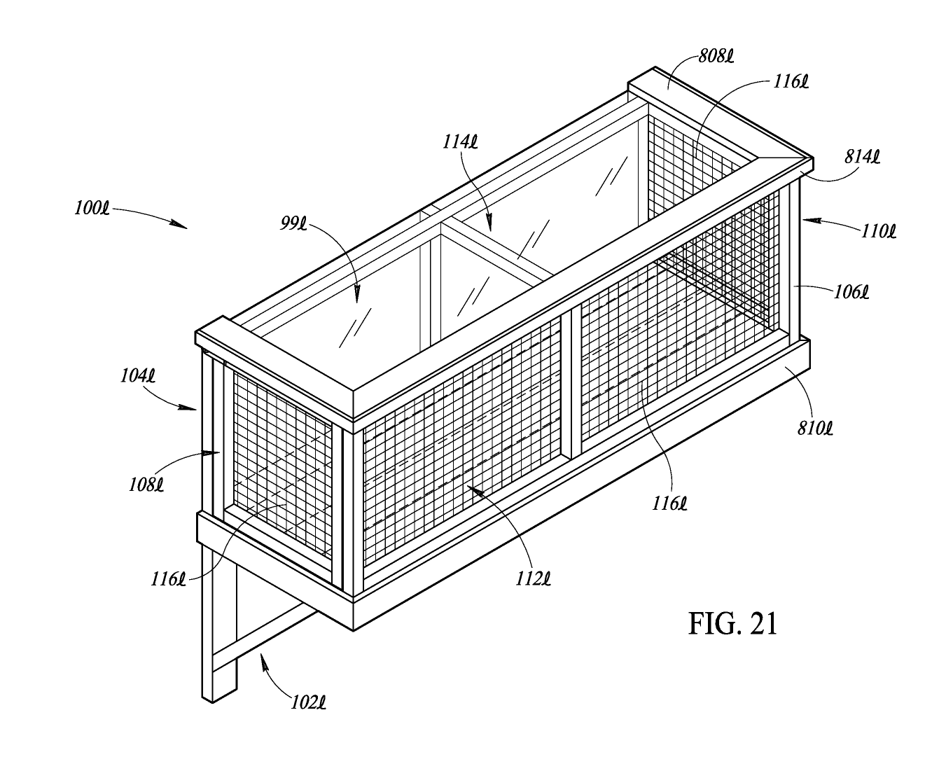

FIGS. 20 through 21 illustrate a window box enclosure 100l according another example embodiment, with an opening 99l. Although not shown for clarity of illustration and description, as described above, the window box enclosure 100l can be coupled to an exterior wall of a home. The window box enclosure 100l includes a frame structure 104l which is constructed via an access door side panel 108l, a side panel 110l, a bottom panel 112l, a front panel 106l, and a top panel 114l, and one or more corbel assemblies 102l. The bottom panel 112l provides a variation in which the bottom panel 112l includes at least three side bottom panel elements 112b disposed in between a pair of side bottom panel elements 112b′ disposed at opposing ends of the bottom panel 112l. As described above and illustrated in FIGS. 20 through 21, the bottom panel 112l also includes a support structure 404l.

As illustrated in FIGS. 20 through 21 and described above, the access door side panel 108l is hingedly coupled to one or more components of the frame structure 104l such that the access door side panel 108l can be hingedly moved between open and closed positions. The access door side panel 108l and the side panel 110l include corresponding wire meshes 116l, which wire meshes 116l are sized and shaped to encompass peripheries of the access door side panel 108l and the side panel 110l. In a similar manner, the front panel 106l also includes a wire mesh 116l. In the illustrated embodiment of the window box enclosure 110l, an optional rear stiffener 140l and an optional front stiffener 141l are provided to stiffen the window box enclosure 100l. For instance, in applications where the length of the window box enclosure 100l has to be extended, the optional front stiffener 141l can be disposed between a length of the front panel 106l and coupled thereto. The optional rear stiffener 140l can be disposed between a length of the top panel 114l and coupled thereto and the bottom panel 112l.

As illustrated in FIGS. 20 through 21, the window box enclosure 100l includes a top trim element 808l and a bottom trim element 810l. The top trim element 810l is coupled to the frame structure 104l and includes a peripheral trim portion 814l. In this embodiment, the window box enclosure 104l includes a top covered roofing material 118l which is disposed between the top trim element 808l and the top panel 114l. The bottom trim element 810l is also coupled to the frame structure 104l.

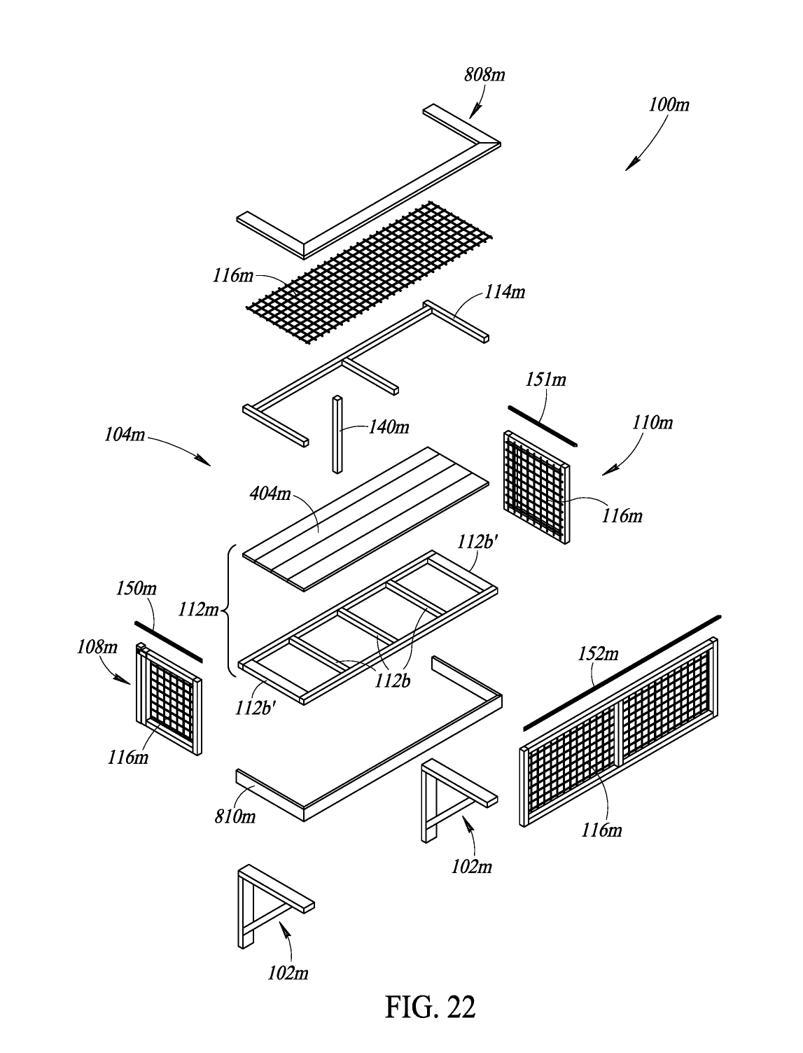

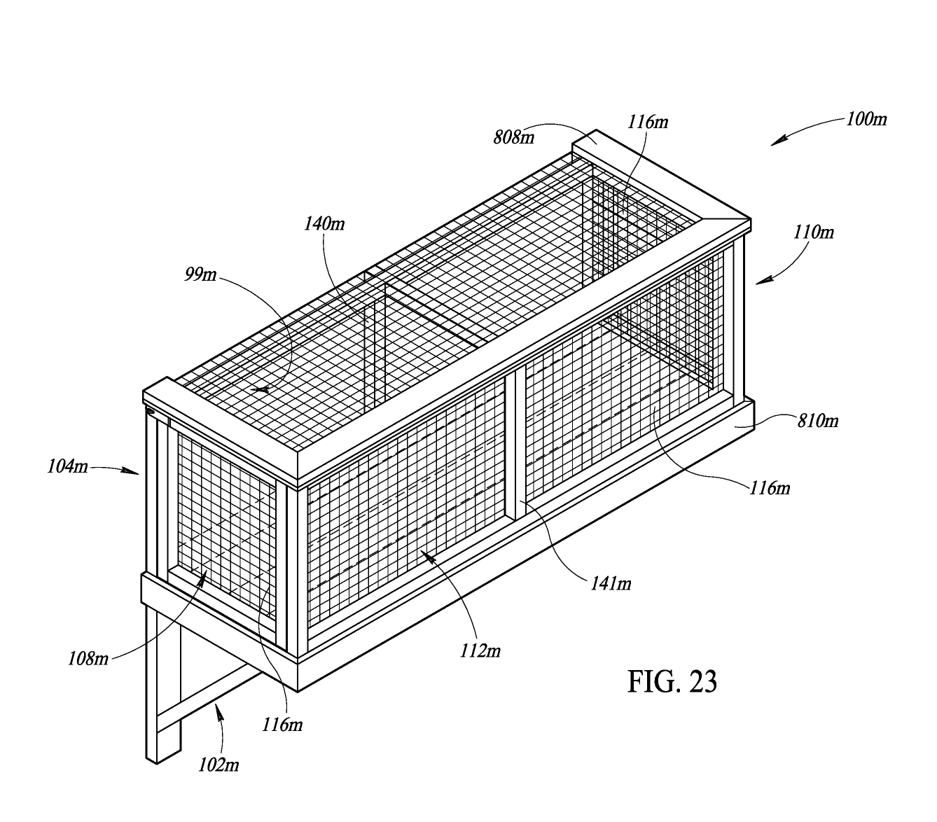

FIGS. 22 through 23 illustrate a window box enclosure 100m according another example embodiment, with an opening 99m. Although not shown for clarity of illustration and description, as described above, the window box enclosure 100m can be coupled to an exterior wall of a home. The window box enclosure 100m includes a frame structure 104m which is constructed via an access door side panel 108m, a side panel 110m, a bottom panel 112m, a front panel 106m, and a top panel 114m, and one or more corbel assemblies 102m. Again, the bottom panel 112m includes at least three side bottom panel elements 112b disposed in between the pair of side bottom panel elements 112b′ disposed at opposing ends of the bottom panel 112m. As described above and illustrated in FIGS. 22 through 23, the bottom panel 112m also includes a support structure 404m. As illustrated in FIGS. 22 through 23 and described above, the access door side panel 108m is hingedly coupled to one or more components of the frame structure 104m such that the access door side panel 108m can be hingedly moved between open and closed positions. The access door side panel 108m and the side panel 110m include corresponding wire meshes 116m, which wire meshes 116m are sized and shaped to encompass peripheries of the access door side panel 108m and the side panel 110m. In a similar manner, the front panel 106m also includes a wire mesh 116m. In the illustrated embodiment of the window box enclosure 110m, an optional rear stiffener 140m and an optional front stiffener 141m are provided to stiffen the window box enclosure 100m. Again, for instance, in applications where the length of the window box enclosure 100m has to be extended, the optional front stiffener 141m can be disposed between a length of the front panel 106m and coupled thereto. The optional rear stiffener 140m can be disposed between a length of the top panel 114m and coupled thereto and the bottom panel 112m.

As illustrated in FIGS. 22 through 23, the window box enclosure 100m includes a top trim element 808m and a bottom trim element 810m. The window box enclosure 100m provides a variation in which the top trim element 808m omits the peripheral trim portion 814l. Again the top trim element 808m is coupled to the frame structure 104m. Moreover, as illustrated in FIGS. 22 through 23, the window box enclosure 100m includes a pair of side trim elements 150m, 151m. The side trim element 150m is positioned adjacent to the access side door panel 108m and can be coupled to the top trip element 808m, and the side trim element 151m is positioned adjacent to the side door panel 110m and can be coupled to the side panel 110m. Furthermore, in this embodiment of the window box enclosure 110m, a wire mesh 116m is disposed between the top trim element 808m and the top panel 114m in lieu of the top covered roofing material 118l. The bottom trim element 810m is also coupled to the frame structure 104m. As described above, the various embodiments of the window box enclosures and their components can comprise wood, metal, plastic, combinations thereof, or any other suitable material. Each of the embodiments of the window box enclosures and their components can be formed via a machining process, molding process (e.g., injection molding process, compression molding process, etc.), etc. Moreover, the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A pet enclosure coupleable to a wall structure of a home adjacent to a window, the window providing a first access point to a pet, the pet enclosure comprising:
a frame structure coupled to the wall structure of the home, the frame structure having an opening which is located adjacent to the window, the frame structure including a second access point; and
a corbel assembly coupled to the frame structure and the wall structure of the home.

2. The pet enclosure of claim 1 wherein the second access point is defined by a access door side panel, the access door side panel pivotably moveable from an open configuration to a closed configuration.

3. The pet enclosure of claim 1 wherein the frame structure includes:
a bottom panel;
a top panel;
an access door side panel;
a side panel; and
a front panel, the front panel, the bottom panel, the access door side panel, and the side panel coupled to each other to form a periphery of the frame structure.

4. The pet enclosure of claim 3 wherein the access door side panel is pivotably moveable from an open configuration to a closed configuration, the access door side panel in the open configuration defining the second access point.

5. The pet enclosure of claim 3 wherein the top panel is rotatably coupled to the access door side panel and the side panel to rotatably move between an open configuration and a closed configuration.

6. The pet enclosure of claim 1 wherein the frame structure includes a top panel, the pet enclosure further comprising:
at least one of a wire cage coupled to the top panel and a top covered roofing material coupled to the top panel.

7. The pet enclosure of claim 6 wherein the wire cage is coupled to the top panel and the top covered roofing material is disposed adjacent to the wire cage, the top covered roofing material slideably moveable from an open configuration to a closed configuration, the top covered roofing material generally extending perpendicularly relative to the wall structure.

8. The pet enclosure of claim 1, further comprising:
a plurality of corbel assemblies, each corbel assembly including:
a top horizontal member;
a back vertical member coupled to the top horizontal member; and
an angled brace member coupled to the top horizontal member and the back vertical member.

9. The pet enclosure of claim 8 wherein the back vertical member is coupled to the external wall structure and the top horizontal member is coupled to the frame structure.

10. The pet enclosure of claim 8 wherein each corbel assembly is spaced apart by a width spacer extending between adjacent corbel assemblies.

11. The pet enclosure of claim 1 wherein the frame structure includes a top panel, the pet enclosure further comprising:
a solid, planar top covered roofing material coupled to the top panel.

12. The pet enclosure of claim 11, further comprising:
a roof shim disposed between the solid, planar top covered roofing material and the top panel, the roof shim sized and shaped to position the solid, planar top covered roofing material at an angle relative to the top panel.

13. The pet enclosure of claim 12, further comprising:
an external trim coupled to the frame structure, the external trim covering a gap defined by an angular position of the solid, planar top covered roofing material relative to the top panel.

14. The pet enclosure of claim 1 wherein the frame structure includes:
a bottom panel; and
a plurality of floor planks coupled to the bottom panel.

15. The pet enclosure of claim 1 wherein the frame structure extends laterally to define a frame structure width, the frame structure width being greater than a width of the window.

16. A pet enclosure coupleable to a wall structure of a home comprising:
a frame structure coupled to the wall structure of the home, the frame structure providing a plurality of access points; and
a corbel assembly coupled to the frame structure and the wall structure of the home.

17. A method comprising:
assembling a window box enclosure, the assembling including constructing a frame structure providing a plurality of access points to a pet;
coupling the window box enclosure to a wall structure of a home; and
coupling a corbel assembly to the frame structure and the wall structure of the home.

18. The method of claim 17 wherein the plurality of access points includes an opening which is located adjacent to a window provided in the wall structure of the home, and wherein the frame structure includes an access door side panel which is moveable between open and closed positions, the access door side panel in the open position providing another access point.

19. The method of claim 17 wherein constructing the frame structure includes providing:
a top panel;
an access door side panel;
a side panel; and
a front panel, the front panel, the bottom panel, the access door side panel, and the side panel coupled to each other to form a periphery of the frame structure.

20. The method of claim 19, further comprising:
coupling at least one of a wire cage and a solid, planar top covered roofing material to the frame structure, the al least one of the wire cage and the solid, planar top covered roofing material disposed between the top panel and a trim element.
